(19) United States
(12) Patent Application Publication
(10) Pub. No.: US 2009/0125572 A1
(43) Pub. Date: May 14, 2009

(54) METHOD FOR MANAGING RETENTION OF DATA ON WORM DISK MEDIA BASED ON EVENT NOTIFICATION

(75) Inventors: David M. Cannon, Tucson, AZ (US); Jonathan M. Haswell, Tucson, AZ (US); David Lebutsch, Tuebingen (DE); Toby L. Marek, Santa Clara, CA (US); Howard N. Martin, Vail, AZ (US)

Correspondence Address: OPPENHEIMER, WOLFF & DONNELLY, LLP, PLAZA VII, SUITE 3300, 45 SOUTH SEVENTH STREET, MINNEAPOLIS, MN, 55402-1609, US

(73) Assignee: International Business Machines Corporation, Armonk, NY (US)

(21) Appl. No.: 11/939,966

(22) Filed: Nov. 14, 2007

(51) Int. Cl. G06F 12/02; G06F 9/44

(52) U.S. Cl. 707/205

(57) ABSTRACT

The present invention provides for a method and a computer system for managing the retention of data on WORM disk media employing an event-based scheme of retaining data. The protection of the files is accomplished by establishing a retention period for the WORM disk media file volume containing the data files, followed by a reclamation period. The retention and reclamation periods are managed by comparing the amount of reclaimable space on the file volume to a threshold value, and if the threshold is not exceeded, the retention period of the file volume is extended by a default retention extension value. If the threshold value is exceeded, the files are moved to another file volume, and the retention period of this target file volume is extended based on the longer of the default retention extension value and the latest expiration date of the file contained within the file volume.

### FIELD OF THE INVENTION

The present invention generally relates to storage-management software applications which provide a repository for computer information that is backed up, archived, or migrated from client nodes in a computer network. The present invention specifically relates to an extension of such storage-management software using a WORM (write once, read many) disk media file volume to support the functionality of event-driven data retention and associated file volume reclamation.

### BACKGROUND OF THE INVENTION

Storage-management servers store data objects (commonly referred to as files) in one or more storage pools, using a database for tracking information about the stored files. Each data object is bound to a policy that manages the life cycle of the object. The policy describes storage parameters for the object, such as storage device destination and number of copies, and information on the data object's life cycle parameters, such as how long the object should be retained before expiration from the server database.

An increasing demand for data retention exists within the IT industry to help satisfy regulatory requirements. For example, Securities and Exchange Commission (SEC) regulations require that securities brokers and other regulated institutions enforce retention requirements for certain records, including email, customer statements, trade settlements, check images, and new account forms. In some cases, the retention is based on an external event, such as closing a brokerage account, while in other cases, records must be retained for a fixed period of time.

The process of general data retention can be performed by existing, commercially-available storage management software applications. Such storage management software operates by allowing other applications to store and retain data, using policy constructs to enforce the retention of files for specified periods of time. Applications can also interact with the storage management software after an external event has occurred which requires the retention of the file for a specified amount of time after the event.

Commercially available hardware storage products also exist to further facilitate the process of data retention. Such hardware products provide the ability to set a retention period for an entire volume of data files, allowing files on the volume to be committed to a WORM state via standard system calls available on most Windows and UNIX based platforms. An application can write a file volume and then commit the file volume to a WORM state which may include specifying how long the volume must be retained before it can expire, allowing the system to determine a retention period for all data objects contained within the file volume. The advantages of using a hardware storage product is that it ties retention requirements to a physical device, enforcing the retention requirements of the individual data objects through the management of a file volume.

Once a file volume is committed to a WORM state, the file volume is unchangeable and undeletable and the files contained therein are immutable for the duration of the specified volume retention period. The retention duration of particular files may be extended, but not reduced, by extending the retention period of the volume or the expiration date of the files stored on the volume. At no point during the volume retention period can the files stored on the file volume be tampered with or changed. After the volume retention period is exceeded, the disk space allocated to the WORM file volume can be reclaimed by a reclamation process. WORM disk media systems employ the reclamation process during a reclamation period that immediately follows the retention period.

The reclamation process reclaims space from an expired file volume by moving unexpired data objects to other active WORM file volumes. This method of reclaiming file volumes adequately handles time-based retention policies because the length of the retention period is calculated when the file volume is created. Existing methods of reclamation, however, fail to efficiently handle data if the data expiration date, and thus the retention period of the file, is unknown or event-driven.

For example, when the WORM file volume contains objects having an unknown expiration date, such as in event-based retention, the data retention period of the WORM file volume will be set to the default of the particular WORM file system. Then, the reclamation process will operate upon a large amount of data that has not yet expired. When the unexpired data is moved to a new file volume, the system will have a minimal life expectancy for the unexpired moved data. Because the unexpired data contained in the new volume is expected to expire soon, the new volume will immediately be a candidate for reclamation, and thus the unexpired data will undergo a continuous cycle of reclamation, being moved from volume to volume until an event occurs which expires the data. The large movement of data causes storage medium thrashing, slowing system performance as resources are consumed to unnecessarily transfer the unexpired data files.

Further, only after the file retention period, commonly known as the expiration date, for the file is has passed can the file be deleted and the file volume be converted to other uses. Another complication is that some files existing in a file volume on WORM disk media may have their expiration date extended, while other files in the volume are allowed to expire, leaving the volume only partly utilized with files which need to be retained. Thus, the need exists for a reclamation process to reclaim space previously taken by expired files and to move unexpired files contained in the file volume to other file volumes but without the unnecessary transfer of unexpired files.

### BRIEF SUMMARY OF THE INVENTION

The present invention provides a new and unique method and system for managing the retention and reclamation of data on WORM disk media, for better use with event-based retention of data files. This method can be used to improve WORM disk storage of file volumes employing a retention period followed by a reclamation period.

In one embodiment of the present invention, a “retention extension” period is introduced which allows the storage management server to set or extend the retention date of the file volume to avoid unnecessary reclamation of a file volume containing unexpired files. This occurs by calculating a threshold value by which the utilization of the file volume is compared, to determine if the file volume is a proper candidate for reclamation. If the file volume is adequately utilized with unexpired file data and does not contain at least the threshold amount of reclaimable file space, then the reclamation process is postponed, and the retention period of the file volume is extended by the length of the retention extension period.

If, however, the file volume contains an amount of expired file data or reclaimable space greater than the predefined threshold, then reclamation is performed upon the file volume. The reclamation process includes moving each of the unexpired data files from the source file volume to a target file volume, to fully reclaim the source file volume disk space. To prevent the target file volume from being identified as a candidate for immediate reclamation, the retention period of the target file volume is extended by the greater of the latest expiration date of each of the unexpired data files and the retention extension period.

This process will be re-applied indefinitely until the data files expire. This functionality helps prevent unnecessary movement of unexpired data, which causes “reclamation thrashing” as files are moved between file volumes on WORM disk media. Although this invention is effective for data managed by event-based retention, it is also applicable for other situations in which the retention period is not known at the time data is first stored in the disk volume. Further, this process can co-exist with a time-based retention strategy on the same WORM disk media and volumes.

### BRIEF DESCRIPTION OF THE DRAWINGS

FIG. 1 illustrates an exemplary operational environment for the management of event-based retention of data on WORM disk media in accordance with one embodiment of the present invention; and

FIG. 2 illustrates a flowchart representative of the event-based retention management method in accordance with one embodiment of the present invention.

### DETAILED DESCRIPTION OF THE INVENTION

The following terms are defined for purposes of facilitating an understanding of the present invention by those having ordinary skill in the art.

The term “WORM disk media” is broadly defined herein as any storage-management disk-based application that provides delete protection for a file stored therein for a specified period of time.

The term “file volume” is broadly defined herein as a storage area within the WORM disk media file system which can retain a group of files in an unchangeable state for a period of time, and contains a retention date and policy separate from the expiration date and policy associated with each of the data files stored within the file volume.

The term “unexpired file” is broadly defined herein as a file that must be retained by the computer system, having yet to reach its expiration date or the occurrence of an event which would trigger its expiration. The term “expired file” is broadly defined herein as a file that has reached its expiration date or has had a event occur which has triggered its expiration, and is a file that no longer must be retained by the computer system.

The term “volume retention period” is broadly defined herein as a period of time that a file volume is securely protected by the WORM disk media wherein the date which corresponds to the last day of the volume retention period is initially calculated to be the greater of a default system policy value for file retention and the latest expiration date of any data file originally stored on the volume.

The term “volume reclamation period” is broadly defined herein as a period of time immediately following the volume retention period lasting for the length of a default system policy value wherein either the reclamation process operates to free up the file volume disk space or the reclamation process is postponed by extending the volume retention period for the file volume.

The presently disclosed method and system of managing retention of data on WORM disk media based on event notification introduces advantages to prevent reclamation thrashing and accompanying degraded performance of a file system. Specifically, the operation of the method for managing retention of data on WORM disk media in accordance with the present invention allows systems employing WORM disk media volumes to efficiently handle the reclamation process by avoiding unnecessary reclamation when the expiration date of file retention is unknown or event-driven.

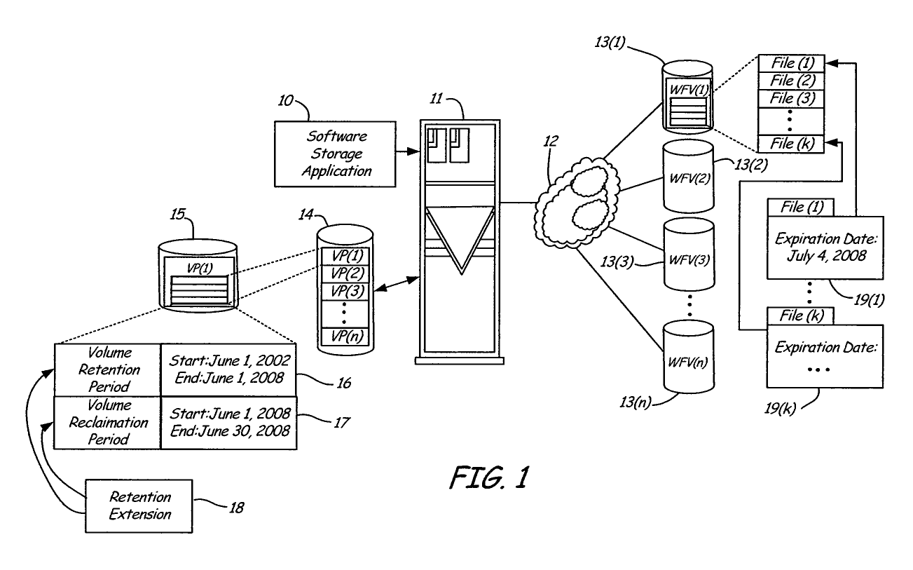

One embodiment of the present invention provides for the interoperation of the software storage application 10 operating on a computer system 11, connected over a network 12 to an array of WORM disk media file volumes 13(1)-(n) containing associated volume policies 14, as is depicted by FIG. 1. In a time-based or event-based retention policy setting, as files 19(1)-(k) are stored on one of the WORM disk media file volumes 13(1), the end date of the volume retention period 16 is set to a length that is the greater of a policy default amount of time and the latest expiration date of any file 19(1)-(k) to be retained on the file volume 13(1). This policy default amount of time may be set to the greater of a retain version variable, a policy setting requiring retention of files for a set period of time, and a retain minimum variable, a policy setting requiring the data to be retained for at least as long as the period as specified by the variable. The retain version variable may be used with time-based retention and the retain minimum variable may be used with event-based retention. The amount of time between the current date and the end retention date is known as the volume retention period 16.

Next, the file volume 13(1) is allocated an amount of time immediately following the volume retention period 16 in which reclamation of the file volume can occur. This period of reclamation, known as the volume reclamation period 17, lasts for a policy-based predefined period, for example, 30 days. Other suitable durations may be used for the volume reclamation period 17, provided the duration of the volume reclamation period 17 is set to a large enough period of time to allow unexpired files to be moved elsewhere to another WORM disk media volume, such as file volume 13(2). At the end of the volume reclamation period 17, the disk space consumed by the file volume 13(1) is freed and may be reused. Thus, the file volume 13(1) will exist as a WORM disk media volume until both the volume retention period 16 and the volume reclamation period 17 have expired.

When the retention period of the file volume 16 is set to the last expiration date of the files 19(1)-(k) stored therein, all data files contained on a file volume 13(1) at the end of the volume retention period 16 are likely to be expired, and therefore the file volume 13(1) will contain only expired files at the beginning of the volume reclamation period 17. However, when the file volume 13(1) enters the reclamation period 17, if there are any files that did not expire, such as files which were modified after their creation to have a later expiration date and thus a longer retention period (depicted as a file with a later expiration date 19(1)), the files 19(1)-(k) can be moved from the source file volume 13(1) to a new file volume 13(2) in the available system storage pool. Once the end of the reclamation period 17 has passed, the source file volume 13(1) is deleted.

When using event-based retention of data files, it is impossible to know when the data files will expire. It is normal for a volume employing event-based retention to reach the end of the volume retention period 16 and the beginning of the volume reclamation period 17 with all data on the volume unexpired and still intact. When the reclamation process is run, the data will be moved to a new target volume 13(2) in the system storage pool. Because the data has existed on the system for longer than the default policy-based volume retention period, the system views the files as having a minimal life expectancy, and as such, the target file volume 13(2) is identified as a good candidate to be reclaimed and immediately enter the volume reclamation period 15. Thereupon, the next time the reclamation process is run on this new target volume 13(2), the process will repeat, thereby moving the data to yet another volume 13(3). This process will continue indefinitely until an intervening event occurs which expires the data. This scenario also occurs when the actual retention time is not known at the time the data files are stored on the WORM disk media. For example, if the system default policy is changed to extend the retention time of data after the data has been stored in a file volume, unnecessary reclamation of the file volume may occur.

The present invention avoids unnecessary reclamation and reclamation thrashing as follows. The data objects stored by the storage software application 10 are initially protected in the WORM disk media file volume for a specified length of time as defined by the storage software policy. If the object has not expired or been deleted at the end of that time, then the object will be re-protected according to the configurable policy, either by extending the retention date of the current file volume 17 or by copying the object to a target volume 13(n) and extending the target volume's retention time 17. This protection will be re-applied indefinitely or until the object is deleted.

At the end of the volume's retention period 14, reclamation will be run against the file volume. If the amount of reclaimable space contained on a file volume exceeds a policy driven threshold, such as a percentage of the disk space that is not utilized, then that volume will be reclaimed and the remaining objects will be copied onto another volume to be protected. If, however, the amount of reclaimable space does not meet the threshold, then this volume will be retained in the system by extending its volume retention date 17, thus eliminating the requirement to copy the data to a new volume if there would be little space saving by doing so.

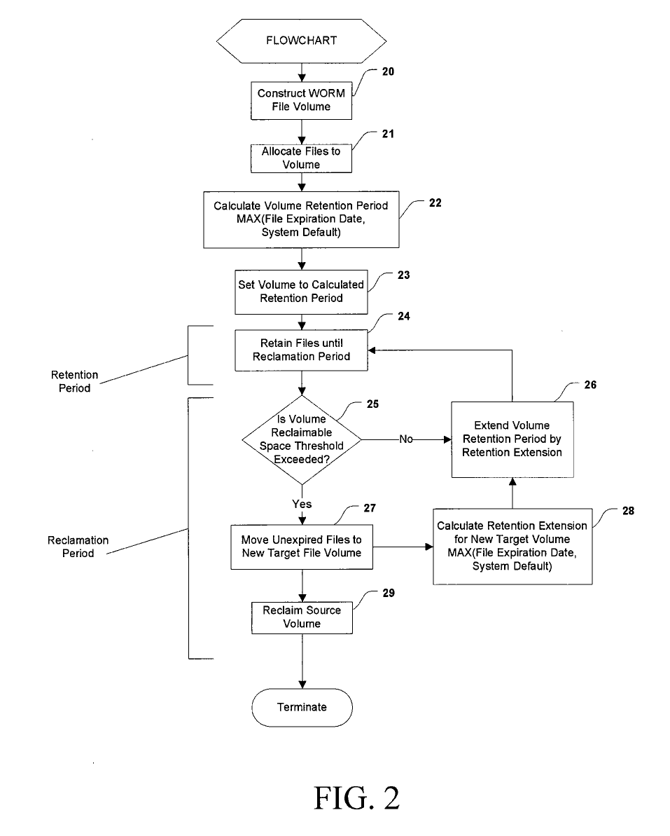

The method to manage event-based data retention on a WORM disk media according to one embodiment of the present invention is shown in the flowchart of FIG. 2. This method operates by first creating a WORM file volume on a WORM disk media as in step 20. Next, the data files intended to be retained will be allocated to the WORM file volume as in step 21. If the retention requirement for the data files (i.e., the file expiration date) is known, then the volume retention period is calculated as the greater of the system default retention period and the longest retention period for each file stored in the volume, as shown in step 22. If the retention requirement for files in the volume is unknown, then the volume retention period is set to the system default retention period. This calculated retention period is then applied to the volume as in step 23.

Next, the data is retained in the file volume for the specified amount of time as in step 24. When the specified retention period has come to an end, the volume enters the reclamation period and the system analyzes whether reclamation should be performed. The reclamation process as shown in step 25 queries whether a reclaimable space threshold is exceeded, such that reclamation will only run if utilization of the volume falls below a policy driven level, meaning that the amount of reclaimable space will have exceeded the volume reclaimable space threshold. Otherwise, if the file volume contains a large enough percentage of unexpired files, reclamation of the volume is not necessary and will not occur. If reclamation is not necessary, then the retention date of the file volume is extended by a retention extension value as in step 26. This value is set according to a defined system policy. As shown in FIG. 1, this retention extension value 18 advances both the volume retention period and the volume reclamation period to a future time period.

If the volume threshold comparison of step 25 determines that the file volume is not adequately utilized, then the volume will be marked for reclamation. The reclamation process then transfers the unexpired data files to a new target file volume as in step 27. To avoid the problem of reclamation thrashing, the retention date of the target file volume is set to the later of the latest expiration date of the unexpired files contained in the target file volume and the current date followed by the retention extension period, as is shown in steps 28 and 26. The target file volume is then retained for the retention period as in step 24, where the process can then repeat.

Once the unexpired files are moved to the target file volume, the disk space consumed by the source file volume can be reclaimed as in step 29. This allows the disk space to be returned to the general use storage pool by the WORM disk media storage system.

Although this process is effective for data managed by event-based retention, it is also applicable for other situations in which retention time is not known at the time data is first stored on WORM disk media. Further, this method can be employed simultaneously with a time-based retention implementation on the WORM disk media.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method in a computer system for managing retention of data on WORM disk media, comprising:
establishing a volume retention period for securely storing data on a file volume on the WORM disk media;
establishing a volume reclamation period to occur immediately after the volume retention period for reclaiming unexpired files within the file volume;
establishing a volume retention extension period for extending the volume retention period;
utilizing the file volume, including retaining files within the file volume for the duration of the volume retention period;
determining during the volume reclamation period whether the amount of reclaimable space on the file volume is greater than a predefined reclamation threshold value;
extending the volume retention period of the file volume by the volume retention extension period if the amount of reclaimable space on the file volume is not greater than the predefined reclamation threshold value; and
reclaiming the file volume if the amount of reclaimable space on the file volume is greater than the predefined reclamation threshold value, including moving each unexpired file contained within the file volume to a target file volume on the WORM disk media and extending the volume retention period of the target file volume to the longer of a remaining retention period of each unexpired file and the length of the retention extension period.

2. The method in a computer system for managing retention of data on WORM disk media as described in claim 1, wherein the WORM disk media is contained on a storage-management hardware application.

3. The method in a computer system for managing retention of data on WORM disk media as described in claim 1, wherein the retention of data is based on event notification.

4. A system, comprising:
at least one processor; and
at least one memory storing instructions operable with the at least one processor for managing retention of data on WORM disk media, the instructions being executed for:
establishing a volume retention period for securely storing data on a file volume on the WORM disk media;
establishing a volume reclamation period to occur immediately after the volume retention period for reclaiming unexpired files within the file volume;
establishing a volume retention extension period for extending the volume retention period;
utilizing the file volume, including retaining files within the file volume for the duration of the volume retention period;
determining during the volume reclamation period whether the amount of reclaimable space on the file volume is greater than a predefined reclamation threshold value;
extending the volume retention period of the file volume by the volume retention extension period if the amount of reclaimable space on the file volume is not greater than the predefined reclamation threshold value; and
reclaiming the file volume if the amount of reclaimable space on the file volume is greater than the predefined reclamation threshold value, including moving each unexpired file contained within the file volume to a target file volume on the WORM disk media and extending the volume retention period of the target file volume to the longer of a remaining retention period of each unexpired file and the length of the retention extension period.
